(19) United States
(12) Patent Application Publication
(10) Pub. No.: US 2023/0261195 A1
(43) Pub. Date: Aug. 17, 2023

(54) BINDER SUITABLE FOR ELECTRICITY STORAGE DEVICE ELECTRODES, BINDER SOLUTION FOR ELECTRICITY STORAGE DEVICE ELECTRODES, ELECTRICITY STORAGE DEVICE ELECTRODE SLURRY, ELECTRICITY STORAGE DEVICE ELECTRODE, AND ELECTRICITY STORAGE DEVICE

(71) Applicant: KURARAY CO., LTD., Okayama (JP)

(72) Inventors: Kengo Tachikawa, Kurashiki-shi, Okayama (JP); Yoshihisa Inui, Kurashiki-shi, Okayama (JP)

(73) Assignee: KURARAY CO., LTD., Okayama (JP)

(21) Appl. No.: 18/010,600

(22) PCT Filed: Jun. 15, 2021
(86) PCT No.: PCT/JP2021/022680

§ 371 Date: Dec. 15, 2022

(30) Foreign Application Priority Data
Jun. 16, 2020 (JP) 2020-103476

(51) Int. Cl. H01M 4/62; C08L 29/04; C08L 27/16; C08L 29/14

(52) U.S. Cl. CPC H01M 4/622; C08L 29/04; C08L 27/16; C08L 29/14; C08L 2203/20; C08L 2205/025

(57) ABSTRACT

The present disclosure provides a binder for electricity storage device electrodes, said binder containing a polyvinyl alcohol resin and an electrolyte solution-swellable resin.

### TECHNICAL FIELD

This patent application claims priority under the Paris Convention based on Japanese Patent Application No. 2020-103476 (filed on Jun. 16, 2020), which is incorporated herein by reference in its entirety.

The present invention relates to: a binder suitable for electricity storage device electrodes; a binder solution for electricity storage device electrodes; an electricity storage device electrode slurry; an electricity storage device electrode; and an electricity storage device.

### BACKGROUND ART

In recent years, mobile terminals such as cellular phones, laptop personal computers, and pad-type information terminal devices have been remarkably widespread. Mobile terminals are demanded to be more comfortably portable and, with the rapid progress of their size reduction, thickness reduction, weight reduction, and performance enhancement, batteries used in such mobile terminals are also required to be reduced in size, thickness, and weight, and provided with enhanced performance. As electricity storage devices used as power sources of such mobile terminals, lithium ion secondary batteries are selected in many cases. Electricity storage devices such as lithium ion secondary batteries have a structure in which a positive electrode and a negative electrode are arranged via a separator and housed in a container together with an electrolyte solution containing a lithium salt such as LiPF₆, LiBF₄, LiTFSI (lithium(bis-trifluoromethylsulfonylimide)), or LiFSI (lithium(bis-fluorosulfonylimide)) dissolved in an organic liquid such as ethylene carbonate.

A negative electrode and a positive electrode that constitute an electricity storage device are usually formed by applying an electrode slurry, which is obtained by dissolving or dispersing a binder and a thickening agent into water or a solvent and mixing the resultant with an active material, a conductive aid (conductivity-imparting agent) and the like, onto a current collector, and subsequently drying the water or solvent to bind the thus dried electrode slurry as a mixed layer.

From the standpoint of reducing the environmental load and improving the simplicity of the device production, the use of an aqueous medium in an electrode slurry has been rapidly advanced particularly in the production of negative electrodes. As a binder to be used in such an electrode slurry for aqueous medium, for example, vinyl alcohol-based polymers, acrylic polymers such as acrylic acid, and amide/imide-based polymers are known (e.g., Patent Documents 1 and 2).

Meanwhile, in the production of positive electrodes, an electrode slurry containing a solvent is generally used. Examples of the solvent include organic solvents such as N-methyl-2-pyrrolidone, dimethylformamide, N,N-dimethylacetamide, N,N-dimethylmethansulfonamide, and hexamethyl phosphoric triamide. As a binder to be used in such an electrode slurry containing an organic solvent, for example, vinylidene fluoride-based polymers, tetrafluoroethylene-based polymers, and fluororubbers are known (e.g., Patent Documents 3 and 4).

### PRIOR ART DOCUMENTS

### Patent Documents

[Patent Document 1]Japanese Laid-Open Patent Publication No. H11-250915
[Patent Document 2] Japanese Laid-Open Patent Publication No. 2017-59527
[Patent Document 3] Japanese Laid-Open Patent Publication No. 2017-107827
[Patent Document 4] Japanese Laid-Open Patent Publication No. 2013-37955

### SUMMARY OF INVENTION

### Technical Problem

Nevertheless, in order to meet the demand for further size reduction, thickness reduction, and weight reduction, both a negative electrode and a positive electrode are required to have an improved energy density. Accordingly, there is an increasing demand for an electrode in which the amount of an active material is increased while the amount of a binder is reduced and, therefore, an electrode having a high peel strength that can inhibit flaking at the time of cutting thereof even when it has a composition containing only a small amount of a binder is desired.

Further, from the standpoint of reducing the charging time, there is a demand for a battery in which a decrease in the capacity is inhibited even when the battery is rapidly charged as opposed to when the battery is slowly charged. An energy loss associated with the internal resistance is believed to be the main cause of a decrease in the capacity during rapid charging; therefore, a low-resistance electrode is desired.

In view of the above-described problems, an object of the present invention is to provide a binder suitable for obtaining an electrode which, when used as an electricity storage device electrode, not only has such a high peel strength that can inhibit flaking at the time of cutting of the electrode but also exhibits a low resistance.

### Solution to Problem

The present inventors intensively studied to discover that an electrode having an excellent peel strength and a low resistance can be obtained by using a binder having a prescribed composition.

That is, the present invention encompasses the following preferred modes.

[1] A binder, comprising:

a polyvinyl alcohol resin; and

an electrolyte solution-swellable resin having an electrolyte solution swelling rate, which is represented by the following equation (1), of 10% by mass or more:

Electrolyte solution swelling rate=((W₂−W₁)/W₁×100) (1)

[wherein, W₁ represents the mass (g) of the resin prior to immersion in an electrolyte solution; and W₂ represents the mass (g) of the resin after 24-hour immersion in diethyl carbonate at 25° C.],

wherein the polyvinyl alcohol resin in the state of an aqueous solution having a solid content concentration of 10% by mass has a viscosity of 4 Pa·s or higher at 25° C. and a shear rate of 10 s⁻¹.

[2] The binder for an electricity storage device electrode according to [1], wherein

the polyvinyl alcohol resin in the state of an aqueous solution having a solid content concentration of 10% by mass has a viscosity of 4 Pa·s to 30 Pa·s at 25° C. and a shear rate of 10 s⁻¹, and

the aqueous solution at 25° C. has a thixotropic index, which is defined as a viscosity ratio between the viscosity at a shear rate of 10 s⁻¹ and the viscosity at a shear rate of 100 s⁻¹, of 1.8 to 5.

[3] The binder for an electricity storage device electrode according to [1] or [2], wherein

the polyvinyl alcohol resin in the state of an N-methyl-2-pyrrolidone solution having a solid content concentration of 7.5% by mass has a viscosity of 4 Pa·s to 35 Pa·s at 25° C. and a shear rate of 10 s⁻¹, and

the solution at 25° C. has a thixotropic index, which is defined as a viscosity ratio between the viscosity at a shear rate of 10 s⁻¹ and the viscosity at a shear rate of 100 s⁻¹, of 2 to 6.

[4] The binder for an electricity storage device electrode according to any one of [1] to [3], wherein the polyvinyl alcohol resin is a vinyl alcohol-based polymer having a crosslinked structure.

[5] The binder for an electricity storage device electrode according to any one of [1] to [4], wherein the polyvinyl alcohol resin has a modification rate of 0.02% by mole to 5% by mole based on the number of moles of all monomer units constituting the polyvinyl alcohol resin.

[6] The binder for an electricity storage device electrode according to any one of [1] to [5], wherein the electrolyte solution-swellable resin has an electrolyte solution elution rate, which is represented by the following equation (2), of 5% by mass or less:

Electrolyte solution elution rate=((W₁−W₃)/W₁×100) (2)

[wherein, W₁ represents the mass (g) of the resin prior to immersion in an electrolyte solution; and W₃ represents the mass (g) of the resin after 24-hour immersion in diethyl carbonate at 25° C. and subsequent 3-hour drying in a hot air dryer at 80° C.].

[7] An electricity storage device electrode, comprising the binder according to any one of [1] to [6].

[8] A binder solution for an electricity storage device electrode, comprising:

the binder according to any one of [1] to [7]; and

a solvent.

[9] An electricity storage device electrode slurry, comprising:

the binder solution for an electricity storage device electrode according to [8]; and

an active material.

[10] The electricity storage device electrode slurry according to [9], wherein the content of the binder solution for an electricity storage device electrode is 0.1 parts by mass to 20 parts by mass with respect to 100 parts by mass of the active material.

[11] An electricity storage device electrode, comprising:

a cured product of the electricity storage device electrode slurry according to [9] or [10]; and

a current collector.

[12] An electricity storage device, comprising the electricity storage device electrode according to [11].

### Advantageous Effects of Invention

According to the present invention, a low-resistance electrode which, when used as an electricity storage device electrode, exhibits such a high peel strength that enables to reduce the amount of a binder to be added in the electrode, can be obtained. Consequently, an electrode which not only hardly shows flaking when cut but also can provide a high capacity even during rapid charging and discharging can be obtained.

Embodiments of the present invention will now be described in detail. It is noted here, however, that the present invention is not limited to the below-described embodiments.

### <Binder (Electricity Storage Device Electrode Binder)>

The binder according to the present invention, which is preferably an electricity storage device electrode binder (hereinafter, also simply referred to as “the binder of the present invention” or “binder”), contains: a polyvinyl alcohol resin; and an electrolyte solution-swellable resin having an electrolyte solution swelling rate of 10% by mass or more as measured by the below-described method.

The polyvinyl alcohol resin, which is one of the components of the binder of the present invention, includes a vinyl alcohol-based polymer and a derivative thereof. A vinyl alcohol-based polymer (hereinafter, also referred to as “polyvinyl alcohol” or simply “PVA”) has a good affinity for active materials used in electricity storage devices, such as carbon materials, metals, and metal oxides; therefore, an electrode having a high peel strength can be obtained by using such a vinyl alcohol-based polymer as the binder.

In the present invention, the PVA in the state of an aqueous solution having a solid content concentration of 10% by mass preferably has a viscosity of 4 Pa·s or higher at 25° C. and a shear rate of 10 s⁻¹ since, as described below, when the PVA is used in the state of an electrode slurry for an electricity storage device (hereinafter, also simply referred to as “the slurry of the present invention” or “slurry”), the adhesion between a cured product of the slurry, particularly an active material that may be contained in the cured product as well as a conductive aid and the like depending on the case, and a current collector is improved, enabling to form an electrode having an excellent peel strength. The above-described viscosity is more preferably 4.5 Pa·s or higher, still more preferably 5 Pa·s or higher, yet still more preferably 6 Pa·s or higher, further preferably 9 Pa·s or higher.

In the present invention, the PVA in the state of an aqueous solution having a solid content concentration of 10% by mass preferably has a viscosity of 30 Pa·s or less at 25° C. and a shear rate of 10 s⁻¹ since this enables to maintain the dispersibility of the active material and the like in the slurry and, as a result, an effect of inhibiting aggregation or precipitation of the active material and the like can be enhanced. The above-described viscosity is more preferably 28.5 Pa·s or less, still more preferably 28 Pa·s or less, yet still more preferably 27.5 Pa·s or less.

In the present invention, the PVA in the state of a prescribed aqueous solution preferably has a thixotropic index (hereinafter, also simply referred to as “TI”), which is defined as a viscosity ratio of the aqueous solution at 25° C. between the viscosity at a shear rate of 10 s⁻¹ and the viscosity at a shear rate of 100 s⁻¹ [(viscosity at shear rate of 10 s⁻¹)/(viscosity at shear rate of 100 s⁻¹)] of 1.8 or higher since this allows a uniform electrode film to be formed when a current collector is coated with the slurry. The thixotropic index is more preferably 2 or higher, still more preferably 2.2 or higher, yet still more preferably 2.22 or higher. Further, the TI is preferably 5 or less since this allows the slurry to maintain its fluidity at rest and have a good coatability, and the TI is more preferably 4 or less, still more preferably 3.5 or less.

In the present invention, the PVA in the state of an N-methyl-2-pyrrolidone (hereinafter, also simply referred to as “NMP”) solution having a solid content concentration of 7.5% by mass (this state is hereinafter also referred to as “prescribed NMP solution state”) preferably has a viscosity of 4 Pa·s or higher at 25° C. and a shear rate of 10 s⁻¹ since, when the PVA is used in the state of a slurry containing NMP as a solvent, the adhesion between a cured product of the slurry, particularly an active material that may be contained in the cured product as well as a conductive aid and the like depending on the case, and a current collector is improved, enabling to form an electrode having an extremely excellent peel strength. The above-described viscosity is more preferably 5 Pa·s or higher, still more preferably 8.5 Pa·s or higher, yet still more preferably 15 Pa·s or higher. Further, the viscosity at 25° C. and a shear rate of 10 s⁻¹ in the above-described prescribed NMP solution state is preferably 35 Pa·s or less since this enables to maintain the dispersibility of the active material and the like in the slurry containing NMP as a solvent and, as a result, an effect of inhibiting aggregation or precipitation of the active material and the like can be enhanced. The above-described viscosity is more preferably 33 Pa·s or less, still more preferably 27 Pa·s or less, yet still more preferably 24 Pa·s or less.

The PVA in the above-described prescribed NMP solution state preferably has a thixotropic index (TI) of 2 or higher since this allows a uniform electrode film to be formed when a current collector is coated with the slurry, and the thixotropic index (TI) is more preferably 2.5 or higher, still more preferably 2.7 or higher. Further, the TI of the PVA in the above-described prescribed NMP solution state is preferably 6 or less since this allows the slurry to maintain its fluidity at rest and have a good coatability, and the TI is more preferably 5 or less, still more preferably 4 or less.

In the present specification, the viscosity of the PVA in the prescribed aqueous solution state or the prescribed NMP solution state at 25° C. and a shear rate of 10 s⁻¹ or 100 s⁻¹ can be measured using, for example, an E-type viscometer with each solution as a measurement sample.

As the PVA, a non-crosslinked and unmodified PVA may be used, and the viscosity thereof may be adjusted by using a thickening agent or the like in combination; however, it is preferred to use a vinyl alcohol-based polymer having a crosslinked structure since this makes it easier to control the viscosity and TI in the prescribed aqueous solution state and the NMP solution state to be in the above-described prescribed ranges.

A method of obtaining the vinyl alcohol-based polymer having a crosslinked structure is not particularly limited. Examples of the method include a method of heat-treating a PVA under a nitrogen or air atmosphere, a method of acid-treating an unmodified PVA, and a method of performing chemical crosslinking using a polyfunctional additive. Alternatively, a modified PVA capable of forming a crosslinked structure may be used.

Examples of an acidic substance that can be used in the method of acid-treating an unmodified PVA include: inorganic acids, such as acetic acid, hydrochloric acid, sulfuric acid, nitric acid, and phosphoric acid; organic acids, such as formic acid, acetic acid, oxalic acid, and p-toluenesulfonic acid; salts, such as pyridinium p-toluenesulfonate and ammonium chloride; and Lewis acids, such as zinc chloride, aluminum chloride, iron trichloride, tin dichloride, tin tetrachloride, and boron trifluoride-diethyl ether complex. Any one of these acidic substances may be used singly, or two or more of these acidic substances may be used in combination. These acidic substances are incorporated in an amount of preferably 0.0001 parts by mass to 5 parts by mass with respect to 100 parts by mass of the PVA.

Examples of a polyfunctional additive that can be used in the method of performing chemical crosslinking using a polyfunctional additive include: dials, such as glyoxal and 1,4-butanedial; diepoxides, such as ethylene glycol diglycidyl ether and diethylene glycol diglycidyl ether; and diisocyanates, such as hexamethylene diisocyanate and toluene diisocyanate. These polyfunctional additives are incorporated in an amount of preferably 0.0001 parts by mass to 5 parts by mass with respect to 100 parts by mass of the PVA.

As the PVA, one obtained by saponification of a vinyl ester-based polymer can be used.

A vinyl ester monomer used for the production of the vinyl ester-based polymer is not particularly limited, and examples thereof include vinyl formate, vinyl acetate, vinyl propionate, vinyl butyrate, vinyl isobutyrate, vinyl pivalate, vinyl versatate, vinyl caproate, vinyl caprylate, vinyl laurate, vinyl palmitate, vinyl stearate, vinyl oleate, and vinyl benzoate. Thereamong, vinyl acetate is preferred from the economic standpoint.

The PVA may be an unmodified PVA consisting of only vinyl alcohol units; however, it is preferred to use a modified PVA that further contains a unit derived from a monomer other than a vinyl alcohol unit, namely a unit derived from a monomer (a), as a modification component since a crosslinked structure can thereby be formed. Specifically, a PVA having a crosslinked structure can be obtained by heating a polymer composed of a vinyl alcohol monomer and a monomer (a) and crosslinking these monomers through the formation of ester bonds.

The monomer (a) may be at least one monomer selected from the group consisting of carboxylic acids having an unsaturated double bond, alkyl esters of the carboxylic acids, acid anhydrides of the carboxylic acids, salts of the carboxylic acids, and silyl compounds having an unsaturated double bond.

Examples of the carboxylic acids having an unsaturated double bond, the alkyl esters of the carboxylic acids, the acid anhydrides of the carboxylic acids, and the salts of the carboxylic acids include maleic acid, monomethyl maleate, dimethyl maleate, monoethyl maleate, diethyl maleate, maleic anhydride, citraconic acid, monomethyl citraconate, dimethyl citraconate, diethyl citraconate, citraconic anhydride, fumaric acid, monomethyl fumarate, dimethyl fumarate, monoethyl fumarate, diethyl fumarate, itaconic acid, monomethyl itaconate, dimethyl itaconate, monoethyl itaconate, diethyl itaconate, itaconic anhydride, acrylic acid, methyl acrylate, ethyl acrylate, methacrylic acid, methyl methacrylate, and ethyl methacrylate.

Examples of the silyl compounds having an unsaturated double bond include compounds having an unsaturated double bond and a trialkoxysilyl group, such as vinyltrimethoxysilane and vinyltriethoxysilane.

Among these monomers (a), from the standpoint of allowing the formation of a crosslinked structure that is likely to control the viscosity, monomethyl maleate, dimethyl maleate, monomethyl citraconate, monomethyl fumarate, monomethyl itaconate, itaconic anhydride, methyl acrylate, methyl methacrylate, or vinyltrimethoxysilane is preferred, and monomethyl maleate, dimethyl maleate, monomethyl fumarate, itaconic anhydride, methyl acrylate, methyl methacrylate, or vinyltrimethoxysilane is more preferred.

The modification rate of the PVA is not particularly limited; however, it is preferably 0.02% by mole to 5% by mole based on the number of moles of all monomer units constituting the PVA. It is noted here that the “modification rate” of the PVA is a content ratio of a unit derived from the monomer (a) based on the number of moles of all monomer units constituting the PVA.

The lower limit of the modification rate is more preferably not less than 0.05% by mole, still more preferably not less than 0.1% by mole, yet still more preferably not less than 0.2% by mole. The upper limit of the modification rate is more preferably 4.5% by mole or less, still more preferably 3% by mole or less, yet still more preferably 1.1% by mole or less. By controlling the modification rate to be in this range, the viscosity and the TI can be easily set in the above-described respective ranges.

As described below in the section of Examples, the modification rate of the PVA can be determined by a method using ¹H-NMR with a vinyl ester-based polymer that is a precursor of the PVA.

The PVA may also contain, within a range that does not impair the effects of the present invention, a unit (structural unit) derived from other monomer in addition to the vinyl alcohol unit and the unit derived from the monomer (a). Examples of the unit derived from other monomer include units derived from any of the followings: α-olefins, such as ethylene, propylene, n-butene, and isobutylene; vinyl ethers, such as methyl vinyl ether, ethyl vinyl ether, n-propyl vinyl ether, i-propyl vinyl ether, n-butyl vinyl ether, i-butyl vinyl ether, t-butyl vinyl ether, and 2,3-diacetoxy-1-vinyloxypropane; vinyl cyanides, such as acrylonitrile and methacrylonitrile; vinyl halides, such as vinyl chloride and vinyl fluoride; vinylidene halides, such as vinylidene chloride and vinylidene fluoride; allyl compounds, such as allyl acetate, 2,3-diacetoxy-1-allyloxypropane, and allyl chloride; and isopropenyl acetate. The content ratio of the unit derived from other monomer in the PVA may be, for example, 15% by mole or less based on the number of moles of all monomer units constituting the PVA.

A sequence order of the vinyl alcohol unit, the unit derived from the monomer (a), and the unit derived from other monomer in the PVA is not particularly limited, and these units may have a random, block, or alternating sequence.

The lower limit of the saponification degree of the PVA (molar fraction of hydroxyl groups with respect to a total amount of hydroxyl groups and ester bonds in the PVA) is preferably not less than 20% by mole, more preferably not less than 60% by mole, still more preferably not less than 70% by mole, yet still more preferably not less than 75% by mole, further preferably not less than 80% by mole. The upper limit of the saponification degree of the PVA may be 100% by mole; however, it is preferably 99.99% by mole or less, more preferably 99% by mole or less. The saponification degree can be measured in accordance with JIS-K6726:1994.

The upper limit of the viscosity-average polymerization degree of the PVA is preferably 5,000 or less, more preferably 4,000 or less. Meanwhile, the lower limit of the viscosity-average polymerization degree of the PVA is preferably not less than 100, more preferably not less than 500, still more preferably not less than 1,000. When the PVA has a crosslinked structure, it is preferred that the viscosity-average polymerization degree of the PVA prior to being crosslinked be in the above-described range. When the PVA has a high viscosity-average polymerization degree, the solution viscosity in the prescribed aqueous solution state or the prescribed NMP solution state is increased. In addition, when the PVA has a high viscosity-average polymerization degree, the solution TI in the prescribed aqueous solution state or the prescribed NMP solution state can be easily adjusted in the above-prescribed range. With the viscosity-average polymerization degree of the PVA being 100 or higher, the viscosity and TI of a binder containing the PVA in the state of an aqueous solution or NMP solution can be easily adjusted in the above-prescribed respective ranges without an excessive reduction, so that the adhesion of an adhesive layer formed by a slurry containing the binder can be improved. Meanwhile, with the viscosity-average polymerization degree of the PVA being 5,000 or less, the viscosity and TI in the state of an aqueous solution or NMP solution are not excessively increased and the productivity of the PVA is improved, so that the PVA can be produced at a lower cost.

The viscosity-average polymerization degree (P) of the PVA can be calculated after completely saponifying and purifying the PVA, and subsequently measuring the intrinsic viscosity [η] (unit: L/g) in a 30° C. aqueous sodium chloride solution (0.5 mol/L) for the PVA containing a unit derived from the monomer (a), or in a 30° C. aqueous solution for the PVA not containing a unit derived from the monomer (a). From the thus measured intrinsic viscosity [η], the viscosity-average polymerization degree (P) of the PVA is calculated using the following equation.

P=([η]×104/8.29)(1/0.62)

The binder of the present invention is suitable for the use in an electricity storage device electrode and, by containing an electrolyte solution-swellable resin in addition to the PVA, the binder of the present invention is likely to improve the ionic conductivity of the electrode. Specifically, the binder of the present invention contains an electrolyte solution-swellable resin having an electrolyte solution swelling rate, which is represented by the following equation (1), of 10% by mass or more preferably 15% by mass or more, more preferably 20% by mass or more:

Electrolyte solution swelling rate=((W₂−W₁)/W₁×100) (1)

[wherein, W₁ represents the mass (g) of the resin prior to immersion in an electrolyte solution; and W₂ represents the mass (g) of the resin after 24-hour immersion in diethyl carbonate at 25° C.].

The electrolyte solution-swellable resin is a polymer that can be swollen with an electrolyte solution to conduct lithium ions, but not electrons. In the present invention, as a method of imparting a resin with electrolyte solution swellability, for example, a method of increasing the free volume between polymer chains by introducing a functional group having a large steric hindrance such as an acetal group or a halogen functional group, or a method of introducing a functional group or monomer unit that has a high affinity for carbonic acid ester solvents can be employed. The electrolyte solution-swellable resin is not limited by any means, and examples thereof include a fluorine-based resin, a polyolefin resin, a polyester resins, a polyacrylic resin, a polyamide resin, a polyurethane resin, a cellulose resin, a carbohydrate resin, a polyol resin, a polyvinyl acetal resin, a polyvinyl formal resin, a polyvinyl acetate resin, and a mixture of two or more of these resins. Specifically, any of the followings, but not limited thereto, can be used: polyvinylidene fluoride (PVdF), polyvinylidene fluoride-hexafluoropropylene (PVdF-HFP), polyvinylidene fluoride-trichloroethylene, polymethyl methacrylate (PMMA), polybutyl acrylate, polyacrylonitrile (PAN), polyvinylpyrrolidone, polyvinyl acetate (PVAc), ethylene-vinyl acetate copolymers, polyethylene oxide (PEO), polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxymethyl cellulose (CMC), polyvinyl acetal, and polyvinyl formal.

The polyvinyl acetal resin has mainly a vinyl alcohol-derived structural unit and a vinyl ester-derived structural unit and, in addition to these structural units, may also contain a structural unit derived from other monomer within a range that does not impair the effects of the present invention. Examples of the other monomer include: α-olefins, such as ethylene, propylene, 1-butene, isobutene, and 1-hexene; unsaturated acids, such as acrylic acid, methacrylic acid, crotonic acid, phthalic acid, phthalic anhydride, maleic acid, maleic anhydride, itaconic acid, and itaconic anhydride, and salts and C1 to C18 alkyl esters of these unsaturated acids; acrylamides, such as acrylamide, C1 to C18 N-alkylacrylamide, N,N-dimethylacrylamide, 2-acrylamide propanesulfonic acid and salts thereof, and acrylamide propyl dimethylamine as well as acid salts and quaternary salts thereof;

methacrylamides, such as methacrylamide, C1 to C18 N-alkylmethacrylamide, N,N-dimethylmethacrylamide, 2-methacrylamide propanesulfonic acid and salts thereof, and methacrylamide propyl dimethylamine as well as acid salts and quaternary salts thereof; N-vinylamides, such as N-vinylpyrrolidone, N-vinylformamide, and N-vinylacetamide; vinyl cyanides, such as acrylonitrile and
methacrylonitrile; vinyl ethers, such as methyl vinyl ether, ethyl vinyl ether, n-propyl vinyl ether, i-propyl vinyl ether, and n-butyl vinyl ether; allyl acetate; allyl ethers, such as propyl allyl ether, butyl allyl ether, and hexyl allyl ether; vinyl halides, such as vinyl chloride, vinyl fluoride, and vinyl bromide; vinylidene halides, such as vinylidene chloride and vinylidene fluoride;
vinylsilanes, such as trimethoxyvinylsilane; oxyalkylene group-containing compounds, such as polyoxyalkylene allyl ethers; isopropenyl acetate; hydroxy group-containing α-olefins, such as 3-buten-1-ol, 4-penten-1-ol, 5-hexen-1-ol, 7-octen-1-ol, 9-decen-1-ol, and 3-methyl-3-buten-1-ol; carboxyl group-containing compounds derived from fumaric acid, maleic acid, itaconic acid, maleic anhydride, phthalic anhydride, trimellitic anhydride or the like; sulfonate group-containing monomers derived from ethylenesulfonic acid, allyl sulfonic acid, methallyl sulfonic acid, 2-acrylamide-2-methyl propanesulfonic acid or the like; and cationic group-containing compounds derived from vinyloxyethyltrimethylammonium chloride, vinyloxybutyltrimethylammonium chloride, vinyloxyethyldimethylamine, vinyloxymethyldiethylamine, N-acrylamide methyltrimethylammonium chloride, N-acrylamide ethyltrimethylammonium chloride, N-acrylamidedimethylamine, allyltrimethylammonium chloride, methallyltrimethylammonium chloride, dimethylallylamine, allylethylamine or the like. Thereamong, from the standpoints of availability and copolymerizability, for example, α-olefins, such as ethylene, propylene, 1-butene, isobutene, and 1-hexene; N-vinylamides, such as N-vinylpyrrolidone, N-vinylformamide, and N-vinylacetamide; vinyl ethers, such as methyl vinyl ether, ethyl vinyl ether, n-propyl vinyl ether, i-propyl vinyl ether, and n-butyl vinyl ether; allyl acetate; allyl ethers, such as propyl allyl ether, butyl allyl ether, and hexyl allyl ether; oxyalkylene group-containing monomers, such as polyoxyalkylene allyl ethers; and hydroxy group-containing α-olefins, such as 3-buten-1-ol, 4-penten-1-ol, 5-hexen-1-ol, 7-octen-1-ol, 9-decen-1-ol, and 3-methyl-3-buten-1-ol are preferred. These monomers may be used singly, or in combination of two or more thereof.

The polymerization degree, the acetalization degree, the saponification degree and the like of the polyvinyl acetal resin are not particularly limited, and any polyvinyl acetal resin can be used. Examples of an aldehyde used for acetalization include: aliphatic aldehydes, such as formaldehyde, acetaldehyde, propylaldehyde, n-butylaldehyde (1-butanol), sec-butylaldehyde, octylaldehyde, and dodecylaldehyde; alicyclic aldehydes, such as cyclohexanecarbaldehyde, cyclooctanecarbaldehyde, trimethylcyclohexanecarbaldehyde, cyclopentylaldehyde, dimethylcyclohexanecarbaldehyde, methylcyclohexanecarbaldehyde, and methylcyclopentylaldehyde; terpene-based aldehydes, such as α-campholenaldehyde, phellandral, cyclocitral, trimethyltetrahydrobenzaldehyde, α-pyrronenealdehyde, myrtenal, dihydromyrtenal, and camphenilone aldehyde; aromatic aldehydes, such as benzaldehyde, naphthaldehyde, anthraldehyde, phenylacetaldehyde, tolualdehyde, dimethylbenzaldehyde, cuminaldehyde, and benzylaldehyde; unsaturated aldehydes, such as cyclohexenealdehyde, dimethylcyclohexenealdehyde, and acrolein; aldehydes having a heterocycle, such as furfural and 5-methyl furfural; hemiacetals, such as glucose and glucosamine; and amino group-containing aldehydes, such as 4-aminobutylaldehyde. These aldehydes may be used singly, or in combination of two or more thereof. Thereamong, aliphatic aldehydes such as n-butylaldehyde (1-butanol) are preferred since they are likely to improve the capacity retention rate of a battery. Further, for example, an aliphatic ketone such as 2-propanone, methyl ethyl ketone, 3-pentanone, or 2-hexanone; an alicyclic ketone such as cyclopentanone or cyclohexanone; or an aromatic ketone such as acetophenone or benzophenone can be used in place of or in combination with an aldehyde.

The electrolyte solution-swellable resin also preferably has a low elution rate in an electrolyte solution since this enables to inhibit a reduction in the durability caused by elution of the binder during the use of an electricity storage device. From this standpoint, the electrolyte solution-swellable resin preferably has an electrolyte solution elution rate, which is represented by the following equation (2), of 5% by mass or less:

Electrolyte solution elution rate=((W₁−W₃)/W₁×100) (2)

[wherein, W₁ represents the mass (g) of the resin prior to immersion in an electrolyte solution; and W₃ represents the mass (g) of the resin after 24-hour immersion in diethyl carbonate at 25° C. and subsequent 3-hour drying in a hot air dryer at 80° C.].

The greater the amount of the electrolyte solution-swellable resin contained in the binder of the present invention, the lower is the resistance. From this standpoint, the content of the electrolyte solution-swellable resin with respect to 100 parts by mass of the PVA is preferably not less than 5 parts by mass, more preferably not less than 10 parts by mass, particularly preferably not less than 15 parts by mass. Meanwhile, the smaller the amount of the electrolyte solution-swellable resin contained in the binder of the present invention, the higher is the peel strength of an electrode. From this standpoint, the content of the electrolyte solution-swellable resin with respect to 100 parts by mass of the PVA is preferably 900 parts by mass or less, more preferably 600 parts by mass or less, particularly preferably 300 parts by mass or less.

The binder of the present invention may further contain a material that adjusts the viscosity of the binder in an aqueous solution state or NMP solution state. Examples of the material that adjusts the viscosity include: polyvalent basic acids, such as citric acid, tartaric acid, and aspartic acid, and salts and condensates thereof; and inorganic substances, such as fumed silica and alumina. The amount of these materials to be added is not particularly limited; however, usually, it is preferably 0.01 parts by mass to 10 parts by mass, more preferably 0.02 parts by mass to 8 parts by mass, still more preferably 0.05 parts by mass to 5 parts by mass, with respect to 100 parts by mass of the binder. The viscosity and TI of the binder of the present invention in a solution state can be further increased and more easily adjusted in the respective prescribed ranges by incorporating a greater amount of the material that adjusts the viscosity. As for an inorganic substance, the smaller the particle size thereof to be incorporated, the more easily can the viscosity and TI of the binder in an aqueous solution state or NMP solution state be increased.

The binder of the present invention or the below-described electricity storage device electrode binder solution of the present invention may further contain an adjuvant within a range that does not impair the effects of the present invention. Examples of the adjuvant include a light stabilizer, a UV absorber, a cryostabilizer, a thickening agent, a leveling agent, a rheology stabilizer, a thixotropic agent, an antifoaming agent, a plasticizer, a lubricant, a preservative, a corrosion inhibitor, an antistatic agent, a charge inhibitor, an anti-yellowing agent, a pH modifier, a film-forming aid, a curing catalyst, a crosslinking reaction catalyst, a crosslinking agent (e.g., glyoxal, a urea resin, a melamine resin, a polyvalent metal salt, a polyisocyanate, or polyamide epichlorohydrin), and a dispersant. These adjuvants can each be selected in accordance with their intended purposes, and may be incorporated in a combination. The content of the adjuvants is, for example, 10% by mass or less, preferably 5% by mass or less, more preferably 1% by mass or less, based on a total amount of the binder or the electricity storage device electrode binder solution.

The binder of the present invention may be obtained by dissolving a PVA in a solvent (water or NMP) along with a component(s) other than the PVA that are incorporated as required to prepare a solution, and subsequently removing the solvent. This solution may be directly used as the below-described electricity storage device electrode binder solution of the present invention in the subsequent slurry preparation. In such a case, a composition of components other than the solvent in the binder solution is the binder of the present invention. In a cured product of the slurry composition of the present invention, the binder of the present invention is contained in a state of being mixed with components such as an active material.

### <Electrode Binder Solution for Electricity Storage Device>

An electrode binder solution for an electricity storage device (hereinafter, also simply referred to as “binder solution” or “the binder solution of the present invention”) can be obtained by dissolving the binder of the present invention in at least one solvent. The solvent is not particularly limited; however, it is preferably water or NMP. The solvent is preferably water from the standpoints of environmental load reduction and equipment simplicity. Meanwhile, the solvent is preferably NMP since, especially when the binder solution is applied as a positive electrode slurry, NMP does not cause deterioration of an active material in the slurry.

In addition to the above-described binder of the present invention, the binder solution may contain an additive that can be dissolved in the solvent (such an additive is hereinafter referred to as “additive A”) within a range that does not impair the effects of the present invention. Examples of the additive A include polyethylene glycol, polyethylene glycol dimethyl ether, polyethylene glycol diglycidyl ether, and polyethyleneimine. The content of the additive A is, for example, 10% by mass or less, preferably 5% by mass or less, more preferably 1% by mass or less, based on a total amount of the binder solution. It is particularly preferred that the binder solution does not contain the additive A.

The binder solution can be obtained by mixing the binder of the present invention, the solvent (water or NMP), and the above-described components other than the binder, which are incorporated as required, by a known method such as stirring. The mixing temperature and mixing time can be adjusted as appropriate in accordance with the type of the solvent. It is noted here that the “binder solution” refers to a solution in a state where the above-described binder is dissolved in a solvent. The phrase “state where the above-described binder is dissolved in a solvent” used herein means a state in which the mass of the binder completely dissolved in the solvent is preferably not less than 80% by mass, more preferably not less than 90% by mass, still more preferably not less than 95% by mass, yet still more preferably not less than 99% by mass, further preferably 100% by mass, with respect to a total mass (100% by mass) of the binder used in the preparation of the binder solution.

The content of the binder in the binder solution of the present invention is preferably 1% by mass to 30% by mass, more preferably 3% by mass to 20% by mass, particularly preferably 5% by mass to 15% by mass, based on a total amount of the binder solution. When the content of the binder is 1% by mass or more, the adhesion of an active material to a current collector in the formation of an electrode is likely to be improved. When the content of the binder is 30% by mass or less, rapid aggregation of an active material in the formation of an electrode can be inhibited.

### <Electricity Storage Device Electrode Slurry>

The electricity storage device electrode slurry according to one embodiment of the present invention contains the above-described binder solution of the present invention and an active material.

The slurry of the present invention may be used for either of a positive electrode and a negative electrode. The slurry of the present invention may be used for both a positive electrode and a negative electrode as well. Accordingly, the active material may be either a positive electrode active material or a negative electrode active material. When the binder solution of the present invention contains water (when the solvent is water), the binder solution preferably contains a negative electrode active material and is used as a negative electrode slurry. When the binder solution of the present invention contains NMP (when the solvent is NMP), the binder solution preferably contains a positive electrode active material and is used as a positive electrode slurry.

As the negative electrode active material, for example, a material conventionally used as a negative electrode active material of an electricity storage device can be used. Examples thereof include: carbonaceous materials, for example, amorphous carbon, artificial graphite, natural graphite (graphite), mesocarbon microbeads (MCMB), pitch-based carbon fibers, carbon black, activated carbon, carbon fibers, hard carbon, soft carbon, mesoporous carbon, and conductive polymers such as polyacene; composite metal oxides represented by SiOₓ, SnOₓ, and LiTiOₓ, and other metal oxides; lithium-based metals such as lithium metal and lithium alloys; metal compounds such as TiS₂ and LiTiS₂; and composite materials formed of a metal oxide and a carbonaceous material. Thereamong, from the standpoints of the economic efficiency and the battery capacity, graphite is preferred, and spherical natural graphite is particularly preferred. These negative electrode active materials may be used singly, or in combination of two or more thereof.

As the positive electrode active material, for example, a material conventionally used as a positive electrode active material of an electricity storage device can be used. Examples thereof include: transition metal oxides, such as TiS₂, TiS₃, amorphous MoS₃, Cu₂V₂O₃, amorphous V₂O—P₂O₅, MoO₃, V₂O₅, and V₆O₁₃; and lithium-containing composite metal oxides, such as LiCoO₂, LiNiO₂, LiMnO₂, and LiMn₂O₄. These positive electrode active materials may be used singly, or in combination of two or more thereof.

The slurry may also contain a conductive aid. The conductive aid is used for increasing the output of an electricity storage device, and can be selected as appropriate depending on whether the slurry is used for a positive electrode or a negative electrode. Examples of the conductive aid include graphite, acetylene black, carbon black, Ketjen black, and vapor-grown carbon fibers. Thereamong, acetylene black is preferred since it is likely to increase the output of the resulting electricity storage device.

When the slurry contains a conductive aid, the content thereof is preferably 0.1 parts by mass to 15 parts by mass, more preferably 1 part by mass to 10 parts by mass, still more preferably 3 parts by mass to 10 parts by mass, with respect to 100 parts by mass of the active material. When the content of the conductive aid is in this range, a sufficient conductivity-assisting effect can be obtained without causing a reduction in the capacity of a battery to which the slurry is applied.

The content of the binder in the slurry is preferably 0.1 parts by mass to 20 parts by mass with respect to 100 parts by mass of the active material. When the content of the binder is 0.1 parts by mass or more, the adhesion of the active material to a current collector is improved, which is advantageous from the standpoint of maintaining the durability of a battery to which the slurry is applied. Further, when the content of the binder is 20 parts by mass or less, the discharge capacity is likely to be improved. From these standpoints, the content of the binder is in a range of more preferably 0.2 parts by mass to 18 parts by mass, still more preferably 0.5 parts by mass to 16 parts by mass, yet still more preferably 1 part by mass to 12 parts by mass.

As required, the slurry may also contain additives such as a flame retardant aid, a thickening agent, an antifoaming agent, a leveling agent, and a tackifier, in addition to the binder, the active material, the conductive aid, and the solvent. When the slurry contains these additives, the content thereof is preferably about 0.1% by mass to 10% by mass based on a total amount of the slurry.

The slurry can be obtained by mixing the binder, the active material and as required, the conductive aid, the solvent, and the additives by an ordinary method using, for example, a mixing machine such as a ball mill, a blender mill, or a three-roll mill.

### <Electricity Storage Device Electrode>

The electricity storage device electrode according to the present specification includes a cured product of the above-described slurry of the present invention and a current collector. The cured product of the slurry is a cured product obtained by removing the solvent from the slurry by drying or the like.

Electrodes (positive electrode and negative electrode) in which the binder of the present invention is used are excellent in terms of the adhesion of their active materials to a current collector. Accordingly, these electrodes have a peel strength of preferably not less than 300 N/m, more preferably not less than 350 N/m, still more preferably not less than 400 N/m, particularly preferably not less than 450 N/m, prior to being immersed in an electrolyte solution. An upper limit value of the peel strength of each electrode is usually 1,000 N/m. The use of an electrode in which the active material is detached from the current collector causes lithium precipitation and thus a short circuit during charging and discharging; therefore, the higher the adhesion between the active material and the current collector, the more preferred it is. The peel strength is preferably in the above-described range since this makes the active material unlikely to be detached from the current collector at the time of punching out or cutting the electrode.

An electrode can be obtained by applying the slurry of the present invention to a current collector and removing the solvent by drying or the like. Further, the electrode may be rolled after the drying.

The current collector is not particularly limited as long as it is made of a conductive material. Examples thereof include metal materials, such as iron, copper, aluminum, nickel, stainless steel, titanium, tantalum, gold, and platinum. These current collectors may be used singly, or in combination of two or more thereof. Among these current collectors, from the standpoints of the adhesion with the active material and the discharge capacity, copper is preferred as a negative electrode current collector, while aluminum is preferred as a positive electrode current collector.

A method of applying the slurry to the current collector is not particularly limited and, for example, a method using an extrusion coater, a reverse roller, a doctor blade, an applicator or the like may be employed. The amount of the slurry to be applied is selected as appropriate in accordance with the desired thickness of a cured product derived from the slurry composition.

Examples of a method of rolling the resulting electrode include mold pressing and roll pressing. From the standpoint of increasing the battery capacity, the pressing pressure is preferably 1 MPa to 40 MPa.

In the electrode, the thickness of the current collector is preferably 1 μm to 20 μm, more preferably 2 μm to 15 μm. The thickness of the cured product is preferably 10 μm to 400 μm, more preferably 20 μm to 300 μm. The thickness of the electrode is preferably from 20 μm to 200 μm.

### <Electricity Storage Device>

The electricity storage device according to one embodiment of the present invention includes the above-described electricity storage device electrode as a negative electrode and/or a positive electrode.

The electricity storage device is, for example, a lithium ion secondary battery, a sodium ion secondary battery, a lithium-sulfur battery, an all-solid-state battery, a lithium ion capacitor, a lithium battery, a nickel-hydrogen battery, or an alkaline dry-cell battery.

An electrolyte solution contained in the battery is a solution that dissolves an electrolyte in a solvent. The electrolyte may be in the form of a liquid or a gel as long as it is used in an ordinary electricity storage device, and any electrolyte that exhibits a function as a battery may be selected as appropriate in accordance with the types of the negative electrode active material and the positive electrode active material. As a specific electrolyte, for example, a known lithium salt can be preferably used, and examples thereof include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H5)₄, CF₃SO₃Li, CH₃SO₃Li, LiCF₃SO₃, LiC₄F₉SO₃, Li(CF₃SO₂)₂N, and a lower aliphatic lithium carboxylate.

A solvent contained in the electrolyte solution is not particularly limited. Specific examples thereof include: carbonates, such as propylene carbonate, ethylene carbonate, butylene carbonate, dimethyl carbonate, ethyl methyl carbonate, diethyl carbonate, and vinylene carbonate; lactones, such as γ-butyl lactone; ethers, such as trimethoxymethane, 1,2-dimethoxyethane, diethyl ether, 2-ethoxyethane, tetrahydrofuran, and 2-methyltetrahydrofuran; sulfoxides, such as dimethyl sulfoxide; oxolanes, such as 1,3-dioxolane and 4-methyl-1,3-dioxolane; nitrogen-containing compounds, such as acetonitrile and nitromethane; organic acid esters, such as methyl formate, methyl acetate, ethyl acetate, butyl acetate, methyl propionate, and ethyl propionate; inorganic acid esters, such as triethyl phosphate, dimethyl carbonate, and diethyl carbonate; diglymes; triglymes; sulfolanes; oxazolidinones, such as 3-methyl-2-oxazolidinone; and sultones, such as 1,3-propane sultone, 1,4-butan sultone, and naphthasultone. These solvents may be used singly, or in combination of two or more thereof. When an electrolyte solution in the form of a gel is used, a nitrile-based polymer, an acrylic polymer, a fluorine-based polymer, an alkylene oxide-based polymer, or the like can be added as a gelling agent.

When the binder of the present invention is used in either a positive electrode or a negative electrode, an ordinary electrode can be used as the other electrode in which the binder of the present invention is not used.

In one preferred embodiment, the battery of the present invention includes an electrode in which the binder of the present invention is used and an ordinary electrode as a negative electrode and a positive electrode, respectively. The positive electrode is not particularly limited as long as it is a positive electrode that is usually used in an electricity storage device.

Alternatively, in another preferred embodiment, the battery of the present invention includes an electrode in which the binder of the present invention is used and an ordinary electrode as a positive electrode and a negative electrode, respectively. The negative electrode is not particularly limited as long as it is a negative electrode that is usually used in an electricity storage device. In this case, it is preferred that: the binder solution of the present invention, which is contained in the slurry of the present invention used for the formation of the positive electrode, be a binder solution containing the binder of the present invention and N-methyl-2-pyrrolidone; and that, as described above, the binder solution has a viscosity of 4 Pa·s to 35 Pa·s at 25° C. and a shear rate of 10 s⁻¹, and a TI, which is defined as a viscosity ratio at 25° C. between the viscosity at a shear rate of 10 s⁻¹ and the viscosity at a shear rate of 100 s⁻¹, of 2 to 6. This is because not only deterioration of the positive electrode active material in the slurry can be inhibited when the solvent in the slurry is NMP, but also the peel strength of the positive electrode can be further improved when the viscosity and TI of the binder NMP solution under the above-described conditions are within the above-described respective prescribed ranges.

Further, the positive electrode and the negative electrode may both be an electrode that contains the binder of the present invention.

A method of producing the battery of the present invention is not particularly limited, and the battery can be produced, for example, in the following manner. That is, a negative electrode and a positive electrode are disposed on one another via a separator such as a polypropylene porous membrane, and the resultant is wound and/or folded according to the shape of the battery and then placed in a battery container, after which an electrolyte solution is injected thereto and this battery container is sealed. The shape of the battery may be any known shape of, for example, a coin type, a button type, a sheet type, a cylindrical type, a square type, or a flat type.

The battery of the present invention is useful for various applications. For example, the battery of the present invention is extremely useful as a battery used in a mobile terminal that requires size reduction, thickness reduction, weight reduction, and performance enhancement. Further, the battery of the present invention can be preferably used as a battery of a device that requires flexibility, such as a wound-type dry-cell battery or a laminated-type battery.

### EXAMPLES

Examples of the present invention will now be described; however, the present invention is not limited thereto. In the below-described Examples, “%” pertains to mass unless otherwise specified. First, measurement methods and evaluation methods will be described. It is noted here that the physical property values (or evaluation values) described herein are based on the values obtained by the following respective methods.

Measurement of the physical property values of each PVA used in the below-described Examples and Comparative Examples, evaluation of binder aqueous solutions and NMP solutions containing each PVA, evaluation in electrode application, and evaluation in battery application were performed in accordance with the following methods.

### <Modification Rate of PVA>

The modification rate of each PVA used in the below-described Examples and Comparative Examples (content ratio of a unit derived from a monomer (a) based on the number of moles of all monomer units of each PVA) was determined by a method using ¹H-NMR with a vinyl ester-based polymer that is a precursor of each PVA.

### <Saponification Degree of PVA>

The saponification degree of each PVA used in the below-described Examples and Comparative Examples was determined in accordance with JIS-K6726:1994.

### <Polymerization Degree of PVA>

The polymerization degree (viscosity-average polymerization degree) of each PVA used in the below-described Examples and Comparative Examples was determined by the method prescribed in JIS-K6726:1994.

For example, when monomethyl maleate is used as the monomer (a), the above-described content ratio can be determined by the following procedure. That is, a vinyl ester-based polymer, which is a precursor of each PVA, is thoroughly purified by reprecipitation at least three times using n-hexane/acetone as a solvent, and the resulting purified product is dried under reduced pressure at 50° C. for 2 days to prepare a sample for analysis. This sample is dissolved in CDCl₃ and measured at room temperature using 1H-NMR. From a peak α (4.7 to 5.2 ppm) derived from the methine structure of the vinyl ester unit contained in the vinyl ester-based polymer and a peak β (3.6 to 3.8 ppm) derived from the methyl group of the methyl ester moiety contained in a unit derived from the monomer (a), the content ratio S of the unit derived from the monomer (a) can be calculated using the following equation:

S(% by mole)={(Number of protons of β/3)/(Number of protons of α+(Number of protons of β/3))}×100

### <Viscosity Measurement and TI Calculation for Binder Aqueous Solution and NMP Solution>

Using either of a binder aqueous solution having a solid content concentration of 10% by mass and a binder NMP solution having a solid content concentration of 7.5% by mass, which were prepared in each of the below-described Examples and the Comparative Examples, as a measurement sample, the viscosity at 25° C. was measured at shear rates of 10 s⁻¹ and 100 s⁻¹ using an E-type viscometer (manufactured by Brookfield Engineering Laboratories, Inc.). Further, from the thus measured values, the TI, which is defined as a viscosity ratio at 25° C. between the viscosity at a shear rate of 10 s⁻¹ and the viscosity at a shear rate of 100 s⁻¹, was calculated.

### <Measurement of Peel Strength (N/m) of Lithium Ion Secondary Battery in Positive Electrode Application>

For each of the lithium ion secondary battery electrodes (positive electrodes) produced in the below-described Examples and Comparative Examples, the strength in peeling of a cured product (a portion derived from the slurry prepared in each of Examples and Comparative Examples) from an aluminum foil (positive electrode) used as a current collector was measured. Specifically, the slurry-coated surface of each lithium ion secondary battery electrode that was produced and a stainless steel plate were pasted together using double-sided adhesive tape (manufactured by Nichiban Co., Ltd.), and the 180° peel strength (peeling width: 10 mm, peeling speed: 100 mm/min) was measured using a 50-N load cell (manufactured by IMADA Co., Ltd.).

### <Measurement of Initial Charge-Discharge Efficiency and Direct-Current Resistance of Lithium Ion Secondary Battery in Positive Electrode Application>

For each of the coin batteries produced in the below-described Examples and Comparative Examples, a test was conducted using a commercially available charge-discharge tester (TOSCAT3100, manufactured by Toyo System Co., Ltd.). The resistance value measured when a current of 0.1 mA was applied for 3 seconds after initial charging was defined as the direct-current resistance. As for charging, the coin battery was charged at a constant current of 0.2 C (about 1 mA/cm²) up to 4.2 V in terms of lithium potential. As for discharging, the coin battery was discharged at a constant current of 0.2 C (about 0.5 mA/cm²) down to 3 V in terms of lithium potential. The coin battery was placed in a 25° C. thermostat chamber and subjected to initial charging and discharging under the above-described conditions, and the charge capacity, the discharge capacity, and the direct-current resistance were measured. The initial charge-discharge efficiency (%) was calculated using the following equation: (Discharge capacity)/(Charge capacity)×100.

### <Measurement of Discharge Capacity Retention Rate (%) of Lithium Ion Secondary Battery in Positive Electrode Application>

For each of the coin batteries produced in the below-described Examples and Comparative Examples, a rate test was conducted using a commercially available charge-discharge tester (TOSCAT3100, manufactured by Toyo System Co., Ltd.). As for charging, the coin battery was charged at a constant current of 0.2 C (about 1 mA/cm²) up to 4.2 V in terms of lithium potential. As for discharging, the coin battery was discharged at a constant current of 0.2 C (about 0.5 mA/cm²) down to 3 V in terms of lithium potential. The coin battery was placed in a 25° C. thermostat chamber and subjected to three cycles of initial charging and discharging under the above-described conditions, after which the coin battery was subjected to one cycle of charging and discharging with the discharge rate being changed to 5 C. The ratio of the discharge capacity at 5 C with respect to the discharge capacity at 0.2 C in this process was defined as the discharge capacity retention rate (%).

### <Evaluation of Occurrence of Breakage of Lithium Ion Secondary Battery Electrodes in Positive Electrode Application>

From each of the lithium ion secondary battery electrodes (positive electrodes) produced in the below-described Examples and Comparative Examples, 10 pieces were punched out using a D14-mm punching machine, and the number of the electrode pieces in which the active material was detached from the current collector was measured.

### (Production of PVAs)

### [PVA-1]

To a reactor equipped with a stirrer, a reflux condenser, a nitrogen introduction tube, a comonomer drip port, and a polymerization initiator addition port, 920 parts by mass of vinyl acetate and 80 parts by mass of methanol were added, and the system was purged with nitrogen for 30 minutes under nitrogen bubbling. Itaconic anhydride was selected as the monomer (a), and a methanol solution thereof (concentration: 20%) was purged with nitrogen by nitrogen bubbling. Heating of the reactor was initiated and, once the internal temperature reached 60° C., polymerization was initiated with an addition of 0.25 parts by mass of 2,2′-azobisisobutyronitrile (AIBN). To this reactor, the above-described methanol solution of itaconic anhydride was added dropwise, and polymerization was carried out at 60° C. for 3 hours while maintaining the monomer composition ratio constant in the polymerization solution, after which the polymerization was terminated by cooling. The total amount of the monomer (a) added until the termination of polymerization was 0.7 parts by mass, and the solid content concentration at the termination of polymerization was 33.3%. Subsequently, unreacted monomers were removed while occasionally adding methanol at 30° C. under reduced pressure, whereby a methanol solution of a vinyl ester-based polymer (concentration: 35%) was obtained. Next, methanol was further added to this methanol solution to prepare another methanol solution of the vinyl ester-based polymer and, to 790.8 parts by mass of the thus prepared methanol solution (containing 200.0 parts by mass of the polymer), 9.2 parts by mass of a 10% methanol solution of sodium hydroxide was added to perform saponification at 40° C. The polymer concentration of the resulting saponification solution was 25%, and the molar ratio of sodium hydroxide with respect to the vinyl acetate unit in the polymer was 0.007. Since a gel-like matter was generated in about 15 minutes after the addition of the methanol solution of sodium hydroxide, the gel-like matter was pulverized using a pulverizer, and the saponification solution was left to stand at 40° C. for 1 hour to allow saponification to proceed. Thereafter, 500 parts by mass of methyl acetate was added to neutralize the remaining alkali. After confirming that the neutralization was completed using a phenolphthalein indicator, the resulting solution was filtered to obtain a white solid. To this white solid, 2,000 parts by mass of methanol was added, and the resultant was left to stand at room temperature for 3 hours, followed by washing. This washing operation was repeated three times, and a white solid obtained by subsequent centrifugal dehydration was heat-treated at 120° C. for 4.5 hours in a dryer, whereby PVA-1 was obtained. The materials used for the production of PVA-1 as well as the physical properties and the like of PVA-1 are summarized in Table 1 below.

### [PVA-2 to PVA-6]

Various PVAs were produced in the same manner as in the production of PVA-1, except that the polymerization conditions such as the added amounts of vinyl acetate and methanol, the type and the amount of the monomer (a) used in the polymerization, and the polymerization rate (reaction rate (%) of monomers (vinyl acetate and monomer (a)) at the termination of polymerization, which is calculated by: 100× (mass of vinyl ester-based polymer at the termination of polymerization)/(amount of added monomers)), as well as the saponification conditions such as the molar ratio of sodium hydroxide were changed as shown in Table 1 below. The physical properties of the thus obtained PVAs are summarized in Table 1 below.

TABLE 1

| | Vinyl acetate | Methanol | Type of | Added amount | Polymerization | NaOH molar |
|---|---|---|---|---|---|---|
| Type | (parts | (parts | monomer | of monomer (a) | rate | ratio in |
| of PVA | by mass) | by mass) | (a) | (parts by mass) | (%) | saponification |
| PVA-1 | 920 | 80 | itaconic | 0.7 | 25 | 0.007 |
| | | | anhydride | | | |
| PVA-2 | 920 | 80 | monomethyl | 0.6 | 25 | 0.01 |
| | | | maleate | | | |
| PVA-3 | 600 | 400 | dimethyl | 7.0 | 60 | 0.01 |
| | | | maleate | | | |
| PVA-4 | 920 | 80 | monomethyl | 4.9 | 25 | 0.007 |
| | | | fumarate | | | |
| PVA-5 | 920 | 80 | vinyltrimethoxysilane | 2.9 | 25 | 0.014 |
| PVA-6 | 920 | 80 | monomethyl | 26.3 | 25 | 0.007 |
| | | | maleate | | | |

### (Production of Polyvinyl Acetal Resins)

### [Polyvinyl Acetal Resin-1]

To a three-necked flask equipped with a reflux condenser and a thermometer, 150 g of acetone, 100 g of water, and 10 g of 1-butanal were added and, while stirring these materials with a magnetic stirrer, 50 g of a polyvinyl alcohol (saponification degree: 99% by mole, average polymerization degree: 1,700) was added over a period of 1 minute. A mixed solution of 50 g of water and 21.2 g of 47%-by-mass sulfuric acid was further added dropwise using a dropping funnel over a period of 5 minutes, and the resultant was heated to 30° C. and allowed to react for 5 hours. After adding a 1-mol/L aqueous sodium hydroxide solution until the pH reached 8, the resulting solid was recovered by filtration. The thus recovered solid was washed five times with a mixed solvent of acetone and water (mass ratio=1:1), and subsequently dried for 6 hours at 120° C. under a pressure of 0.005 MPa, whereby a polyvinyl acetal resin having a hydroxyl equivalent of 74 was obtained. The polymer used in the below-described binder solution is summarized in Table 2 below.

### [Polyvinyl Acetal Resin-2]

A polyvinyl acetal resin-2 was produced in the same manner as the production method of [Polyvinyl Acetal Resin-1], except that 1-nonanal was used in place of 1-butanal and the polyvinyl alcohol (saponification degree: 99% by mole, average polymerization degree: 1,700) was changed to a polyvinyl alcohol (saponification degree: 99% by mole, average polymerization degree: 2,400). The polymer used in the below-described binder solution is summarized in Table 2 below.

The following Examples and Comparative Examples represent the use of the above-produced PVA-1 to PVA-6 for the formation of a positive electrode.

### Preparation of Aqueous PVA Solution

PVA-1 was used as a PVA that is a constituent of a binder. First, the modification rate, the saponification degree, and the polymerization degree of PVA-1 were determined by the above-descried methods. Next, water was added to PVA-1, and the resultant was mixed with heating at 80° C. for 1 hour to obtain an aqueous PVA solution which contained a vinyl alcohol-based polymer and had a solid content concentration of about 10% by mass. The solid content concentration was calculated from the mass of remaining solid after weighing 3 g of the aqueous PVA solution in an aluminum cup and drying it in a hot air dryer at 105° C. for 3 hours. For the aqueous PVA solution, the viscosity was measured and the TI was calculated by the above-described respective methods. The physical properties (modification rate, saponification degree, and polymerization degree) of the PVA and the physical properties (viscosity and TI) of the aqueous PVA solution are summarized in Table 3 below.

### Example 1

### Preparation of NMP Solution of PVA

In Example 1, PVA-1 was used as a PVA (hereinafter, also referred to as “resin a”) that is a constituent of a binder. NMP (manufactured by FUJIFILM Wako Pure Chemical Corporation) in an amount of 92.5 parts by mass was added to 7.5 parts by mass of PVA-1, and these materials were heated to 80° C. with stirring, and then further heated with stirring until complete dissolution was visually confirmed, whereby an NMP solution of PVA, which contained a vinyl alcohol-based polymer and had a solid content concentration of about 7.5% by mass, was obtained. The solid content concentration was calculated from the mass of remaining solid after weighing 3 g of the solution of PVA in an aluminum cup and drying it in a hot air dryer at 120° C. for 4 hours. For the NMP solution of PVA, the viscosity was measured and the TI was calculated by the above-described respective methods. Further, for the NMP solution of PVA, the NMP solubility was evaluated by the above-described method. The physical properties (modification rate, saponification degree, and polymerization degree) of the PVA and the physical properties (viscosity and TI) of the NMP solution of PVA are summarized in Table 3 below.

### Preparation of Binder Solution

A binder solution was prepared by mixing the above-obtained NMP solution of PVA and an NMP solution of KYNAR (registered trademark) HSV900 (PVdF, manufactured by Arkema K. K.) used as an electrolyte solution-swellable resin such that the ratio of the PVA and the electrolyte solution-swellable resin (PVA:electrolyte solution-swellable resin) was 1:9. A non-PVA resin containing an electrolyte solution-swellable resin is hereinafter also referred to as “resin b”.

### Preparation of Positive Electrode Slurry

Further, a positive electrode slurry was prepared by adding the above-obtained binder solution, NCM (“CELLSEED C-5H”, manufactured by Nippon Chemical Industrial CO., Ltd.) as a positive electrode active material, and Super-P (manufactured by TIMCAL Ltd.) as a conductive aid (conductivity-imparting agent) to a dedicated container and kneading these materials using a planetary stirrer (ARE-250, manufactured by THINKY Corporation). In this addition, the solid content in the binder solution was 3 parts by mass, the solid content of NCM was 95 parts by mass, and the solid content of Super-P was 2 parts by mass. In other words, the composition ratio of the active material, the conductive aid, and the binder in the positive electrode slurry (NCM powder:conductive aid:binder) was 95:2:3 (mass ratio) in terms of solid content.

### Production of Positive Electrode for Lithium Ion Secondary Battery

The positive electrode slurry obtained in the above-described manner was applied onto a current collector formed of an aluminum foil (CST8G, manufactured by Fukuda metal Foil & Powder Co., Ltd.) using a bar coater (T101, manufactured by Matsuo Sangyo Co., Ltd.). This current collector was subjected to 30-minute primary drying at 80° C. in a hot air dryer and then a rolling process using a roll press (manufactured by Hohsen Corp.). Subsequently, the thus rolled current collector was punched out as a battery electrode (φ14 mm), which was then subjected to 3-hour secondary drying at 140° C. under reduced pressure to produce a coin battery positive electrode. A total of ten φ14 mm punched-out electrodes were produced, and the number of broken electrodes was counted. Further, an unbroken electrode was selected as the electrode to be used in a coin battery. For the thus obtained coin battery positive electrode, the peel strength was measured by the above-described method. The results thereof are summarized in Table 4 below.

### Production of Lithium Ion Secondary Battery

The battery positive electrode obtained in the above-described manner was transferred to a glove box (manufactured by Miwa Manufacturing Co., Ltd.) in an argon gas atmosphere. A lithium metal foil (0.2 mm in thickness, φ16 mm) and a polypropylene film (CELGARD #2400, manufactured by Polypore International, Inc.) were used as a negative electrode and a separator, respectively, and a mixed solvent system (1M-LiPF₆, EC/EMC=3/7% by volume, VC: 2% by mass) obtained by adding vinylene carbonate (VC) to ethylene carbonate (EC) and ethyl methyl carbonate (EMC) for lithium hexafluorophosphate (LiPF₆) was injected as an electrolyte solution. A coin battery (2032-type) was produced according to this configuration. For the thus obtained coin battery, the initial charge-discharge efficiency, the 5C discharge capacity retention rate, and the direct-current resistance were measured by the above-described respective methods. The results thereof are summarized in Table 4 below.

### Examples 2 to 22

A binder solution and a positive electrode slurry were prepared and a positive electrode for lithium ion secondary battery and a lithium ion secondary battery were produced in the same manner as in Example 1, except that the resin a and the resin b were each selected from the resins shown in Table 2 and the ratio of the resin a and the resin b (resin a:resin b) was changed as shown in Table 4, and the same measurements and evaluations were performed. The results thereof are summarized in Tables 3 and 4 below.

### Comparative Examples 1 to 17

A binder solution and a positive electrode slurry were prepared and a positive electrode for lithium ion secondary battery and a lithium ion secondary battery were produced in the same manner as in Example 1, except that the resin a and the resin b were each selected from the resins shown in Table 2 and the ratio of the resin a and the resin b (resin a:resin b) was changed as shown in Table 4, and the same measurements and evaluations were performed. The results thereof are summarized in Tables 3 and 4 below.

TABLE 2

| | | Swelling rate | Elution rate |
|---|---|---|---|
| | Resin Type | [% by mass] | [% by mass] |
| Resin 1 | PVA-1 | <1 | <1 |
| Resin 2 | PVA-2 | <1 | <1 |
| Resin 3 | PVA-3 | <1 | <1 |
| Resin 4 | PVA-4 | <1 | <1 |
| Resin 5 | PVA-5 | <1 | <1 |
| Resin 6 | PVA217 (manufactured by | <1 | <1 |
| | Kuraray Co., Ltd.) | | |
| Resin 7 | Polyvinyl acetal resin-1 | 2 | <1 |
| Resin 8 | PVDF#1120 (PVDF | 6 | <1 |
| | manufactured by Kureha Corp.) | | |
| Resin 9 | KYNER HSV900 (PVDF | 13 | <1 |
| | manufactured by Arkema K.K.) | | |
| Resin 10 | PVDF-HFP (manufactured by | 16 | <1 |
| | Sigma-Aldrich Co., LLC.) | | |
| Resin 11 | Polyvinyl acetal resin-2 | 45 | 2 |
| Resin 12 | PVA-6 | <1 | <1 |
| Resin 13 | PVA235 (manufactured by | <1 | <1 |
| | Kuraray Co., Ltd.) | | |

*PVA217: saponification degree = 88, polymerization degree = 1,700
*PVA235: saponification degree = 88, polymerization degree = 3,500

TABLE 3

| | | | | | | TI value | | | TI value |
|---|---|---|---|---|---|---|---|---|---|
| | | | | | | (viscosity at | | | (viscosity at |
| | | | | Viscosity | Viscosity | 10 s⁻¹/ | Viscosity | Viscosity | 10 s⁻¹/ |
| | | | | of aqueous | of aqueous | viscosity at | of NMP | of NMP | viscosity at |
| | Modifi- | Saponifi- | Polymeri- | solution at | solution at | 100 s⁻¹) | solution at | solution at | 100 s⁻¹) |
| Type of | cation | cation | zation | 10 s⁻¹ | 100 s⁻¹ | (aqueous solution | 10 s⁻¹ | 100 s⁻¹ | (NMP solution |
| PVA | rate | degree | degree | [Pa · s] | [Pa · s] | viscosity) | [Pa · s] | [Pa · s] | viscosity) |
| PVA-1 | 0.2 | 80 | 3,500 | 14.594 | 6.985 | 2.01 | 15.178 | 5.588 | 2.72 |
| PVA-2 | 0.2 | 88 | 3,500 | 15.633 | 7.051 | 2.22 | 15.507 | 5.739 | 2.70 |
| PVA-3 | 1.1 | 88 | 1,000 | 4.852 | 2.651 | 1.83 | 5.240 | 2.041 | 2.57 |
| PVA-4 | 1.1 | 80 | 3,500 | 22.367 | 6.540 | 3.42 | 23.485 | 4.905 | 4.79 |
| PVA-5 | 0.2 | 95 | 3,500 | 27.388 | 11.179 | 2.45 | 30.127 | 8.272 | 3.64 |
| PVA-6 | 7.6 | 80 | 3,500 | 32.134 | 7.994 | 4.02 | 41.774 | 5.596 | 7.47 |
| PVA217 | 0 | 88 | 1,700 | 0.824 | 0.545 | 1.51 | 0.783 | 0.474 | 1.65 |
| PVA235 | 0 | 88 | 3,500 | 8.362 | 5.049 | 1.66 | 8.028 | 4.544 | 1.77 |

TABLE 4

| | | | | | Initial | 5C discharge | | Occurrence |
|---|---|---|---|---|---|---|---|---|
| | | | Resin | | charge- | capacity | Direct- | of |
| | | | mixing | Peel | discharge | retention | current | breakage |
| | PVA | Non-PVA | ratio | strength | efficiency | rate | resistance | [number of |
| | (resin a) | (resin b) | (a:b) | [N/m] | [%] | [%] | [Ω] | electrodes] |
| Example 1 | Resin 1 | Resin 9 | 1:9 | 431 | 87 | 79 | 680 | 0 |
| Example 2 | Resin 1 | Resin 9 | 5:5 | 542 | 86 | 76 | 702 | 0 |
| Example 3 | Resin 1 | Resin 9 | 9:1 | 603 | 84 | 74 | 715 | 0 |
| Example 4 | Resin 1 | Resin 10 | 5:5 | 504 | 85 | 75 | 643 | 0 |
| Example 5 | Resin 2 | Resin 9 | 5:5 | 579 | 86 | 77 | 734 | 0 |
| Example 6 | Resin 2 | Resin 10 | 1:9 | 415 | 87 | 78 | 621 | 0 |
| Example 7 | Resin 2 | Resin 10 | 5:5 | 537 | 86 | 77 | 654 | 0 |
| Example 8 | Resin 2 | Resin 10 | 9:1 | 649 | 85 | 75 | 667 | 0 |
| Example 9 | Resin 2 | Resin 11 | 1:9 | 597 | 87 | 77 | 678 | 0 |
| Example 10 | Resin 2 | Resin 11 | 9:1 | 559 | 85 | 75 | 706 | 0 |
| Example 11 | Resin 3 | Resin 9 | 5:5 | 411 | 86 | 78 | 691 | 0 |
| Example 12 | Resin 3 | Resin 10 | 8:2 | 406 | 85 | 75 | 741 | 0 |
| Example 13 | Resin 4 | Resin 9 | 9:1 | 672 | 85 | 74 | 739 | 0 |
| Example 14 | Resin 4 | Resin 9 | 5:5 | 631 | 86 | 78 | 683 | 0 |
| Example 15 | Resin 4 | Resin 10 | 5:5 | 623 | 85 | 77 | 672 | 0 |
| Example 16 | Resin 4 | Resin 11 | 5:5 | 615 | 86 | 77 | 689 | 0 |
| Example 17 | Resin 5 | Resin 9 | 5:5 | 692 | 86 | 78 | 674 | 0 |
| Example 18 | Resin 5 | Resin 10 | 9:1 | 709 | 85 | 75 | 725 | 0 |
| Example 19 | Resin 5 | Resin 10 | 5:5 | 664 | 87 | 77 | 701 | 0 |
| Example 20 | Resin 5 | Resin 11 | 9:1 | 671 | 85 | 75 | 733 | 0 |
| Example 21 | Resin 12 | Resin 9 | 5:5 | 731 | 82 | 65 | 867 | 0 |
| Example 22 | Resin 13 | Resin 9 | 5:5 | 523 | 82 | 68 | 827 | 0 |
| Comparative | Resin 1 | none | 10:0 | 642 | 82 | 62 | 1,055 | 0 |
| Example 1 | | | | | | | | |
| Comparative | Resin 2 | none | 10:0 | 683 | 82 | 61 | 1,127 | 0 |
| Example 2 | | | | | | | | |
| Comparative | Resin 3 | none | 10:0 | 420 | 81 | 60 | 1,154 | 0 |
| Example 3 | | | | | | | | |
| Comparative | Resin 4 | none | 10:0 | 701 | 82 | 61 | 1,033 | 0 |
| Example 4 | | | | | | | | |
| Comparative | Resin 5 | none | 10:0 | 754 | 80 | 62 | 1,076 | 0 |
| Example 5 | | | | | | | | |
| Comparative | Resin 6 | none | 10:0 | 339 | 81 | 59 | 1,209 | 1 |
| Example 6 | | | | | | | | |
| Comparative | none | Resin 7 | 0:10 | 412 | 84 | 63 | 988 | 0 |
| Example 7 | | | | | | | | |
| Comparative | none | Resin 8 | 0:10 | 25 | 84 | 64 | 979 | 4 |
| Example 8 | | | | | | | | |
| Comparative | none | Resin 9 | 0:10 | 112 | 91 | 82 | 645 | 2 |
| Example 9 | | | | | | | | |
| Comparative | none | Resin 10 | 0:10 | 31 | 88 | 81 | 596 | 3 |
| Example 10 | | | | | | | | |
| Comparative | none | Resin 11 | 0:10 | 311 | 88 | 80 | 622 | 1 |
| Example 11 | | | | | | | | |
| Comparative | none | Resin 12 | 0:10 | 53 | 72 | 55 | 648 | 3 |
| Example 12 | | | | | | | | |
| Comparative | none | Resin 13 | 0:10 | 21 | 74 | 53 | 673 | 4 |
| Example 13 | | | | | | | | |
| Comparative | Resins 1 | none | 10:0 | 483 | 81 | 60 | 1,170 | 0 |
| Example 14 | and 6* | | | | | | | |
| Comparative | Resin 4 | Resin 8 | 5:5 | 289 | 82 | 61 | 1,056 | 1 |
| Example 15 | | | | | | | | |
| Comparative | Resin 2 | Resin 7 | 5:5 | 522 | 82 | 62 | 1,091 | 0 |
| Example 16 | | | | | | | | |
| Comparative | Resin 6 | Resin 9 | 5:5 | 17 | 81 | 67 | 836 | 2 |
| Example 17 | | | | | | | | |

*mixed at Resin 1: Resin 6 = 5:5

As shown in Table 4 above, in Examples, not only the electrodes had a higher peel strength and were less likely to be broken when cut, but also the batteries had a higher initial charge-discharge efficiency, a higher 5C discharge capacity retention rate, and a lower direct-current resistance, as compared to those of Comparative Examples.

1: A binder, comprising:
a polyvinyl alcohol resin; and
an electrolyte solution-swellable resin having an electrolyte solution swelling rate, which is represented by the following equation (1), of 10% by mass or more:
Electrolyte solution swelling rate=((W₂−W₁)/W_{1×100}) (1)
[wherein, W₁ represents the mass (g) of the resin prior to immersion in an electrolyte solution; and W₂ represents the mass (g) of the resin after 24-hour immersion in diethyl carbonate at 25° C.],
wherein the polyvinyl alcohol resin in the state of an aqueous solution having a solid content concentration of 10% by mass has a viscosity of 4 Pa·s or higher at 25° C. and a shear rate of 10 s⁻¹.

2: The binder according to claim 1, wherein
the polyvinyl alcohol resin in the state of an aqueous solution having a solid content concentration of 10% by mass has a viscosity of 4 Pa·s to 30 Pa·s at 25° C. and a shear rate of 10 s⁻¹, and
the aqueous solution at 25° C. has a thixotropic index, which is defined as a viscosity ratio between the viscosity at a shear rate of 10 s⁻¹ and the viscosity at a shear rate of 100 s⁻¹, of 1.8 to 5.

3: The binder according to claim 1, wherein
the polyvinyl alcohol resin in the state of an N-methyl-2-pyrrolidone solution having a solid content concentration of 7.5% by mass has a viscosity of 4 Pa·s to 35 Pa·s at 25° C. and a shear rate of 10 s⁻¹, and
the solution at 25° C. has a thixotropic index, which is defined as a viscosity ratio between the viscosity at a shear rate of 10 s⁻¹ and the viscosity at a shear rate of 100 s⁻¹, of 2 to 6.

4: The binder according to claim 1, wherein the polyvinyl alcohol resin is a vinyl alcohol-based polymer having a crosslinked structure.

5: The binder according to claim 1, wherein the polyvinyl alcohol resin has a modification rate of 0.02% by mole to 5% by mole based on the number of moles of all monomer units constituting the polyvinyl alcohol resin.

6: The binder according to claim 1, wherein the electrolyte solution-swellable resin has an electrolyte solution elution rate, which is represented by the following equation (2), of 5% by mass or less:
Electrolyte solution elution rate=((W₁−W₃)/W₁×100) (2)
[wherein, W₁ represents the mass (g) of the resin prior to immersion in an electrolyte solution; and W₃ represents the mass (g) of the resin after 24-hour immersion in diethyl carbonate at 25° C. and subsequent 3-hour drying in a hot air dryer at 80° C.].

7: An electricity storage device electrode, comprising the binder according to claim 1.

8: A binder solution for an electricity storage device electrode, comprising:
the binder according to claim 1; and
a solvent.

9: An electricity storage device electrode slurry, comprising:
the binder solution for an electricity storage device electrode according to claim 8; and
an active material.

10: The electricity storage device electrode slurry according to claim 9, wherein the content of the binder for an electricity storage device electrode is 0.1 parts by mass to 20 parts by mass with respect to 100 parts by mass of the active material.

11: An electricity storage device electrode, comprising:
a cured product of the electricity storage device electrode slurry according to claim 9; and
a current collector.

12: An electricity storage device, comprising the electricity storage device electrode according to claim 11.
